(19) United States
(12) Patent Application Publication
(10) Pub. No.: US 2009/0288531 A1
(43) Pub. Date: Nov. 26, 2009

(54) Method and apparatus for the removal of punch waste

(75) Inventor: Timo Steimer, Spaichingen (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Maschinenfabrik Spaichingen GmbH, Spaichingen (DE)

(21) Appl. No.: 12/378,861

(22) Filed: Feb. 19, 2009

(30) Foreign Application Priority Data
Feb. 20, 2008 (DE) 102008010127.3

(51) Int. Cl. B21D 45/04; B26D 7/18; B26F 1/14

(52) U.S. Cl. 83/24; 83/23; 83/143; 83/98; 83/701; 83/100

(57) ABSTRACT

In a method for the removal of punch waste on punching, in particular punching using knife attachment cutting, in which, for the production by means of a punch blade of a punched opening in a workpiece supported at the end face of a cylindrical anvil, a part of the workpiece is punched out and the punched out part lies before its removal on a base, in particular a resilient base, movable axially in the cylindrical anvil, the movable base is retracted together with the punched out part into the cylindrical anvil up to and into the region of a lateral ejection opening provided in the cylindrical anvil and the punched out part supported on the retracted base is subsequently ejected through the ejection opening by loading with a corresponding force transversely to the axial direction. In addition, an apparatus for the carrying out of the method is set forth.

The invention relates to a method for the removal of punch waste on punching, in particular punching using knife attachment cutting, in which, for the production by means of a punch blade of a punched opening in a workpiece supported at the end face of a cylindrical anvil, a part of the workpiece is punched out and the punched out part lies before its removal on a base, in particular a resilient base, movable axially in the cylindrical anvil. It furthermore relates to an apparatus in accordance with the preamble of claim 16.

When punching using the so-called knife attachment cutting technique, which is in particular used for the manufacture of smaller openings, for example in automotive bumpers for a distance sensor system or a headlamp cleaning system, problems occur in connection with the removal and defined disposal of the punched out part.

It was previously generally customary for the removal of the punched out part to use a vacuum gripper system specifically adapted to the respective case, which, however, gives rise to the following problems:

The vacuum gripper must thus be newly adapted for each punched out part. For reasons of space, a defined removal is not possible in every case. In addition, the part collection can only take place after the punched out workpiece has been removed, which can result in increases in the cycle time. Dangerous movements can in particular also occur with larger workpieces with an open roller shutter since the waste removal is only possible after the removal of the large workpiece. However, this is now in particular contrary to corresponding safety regulations in the USA. Since the vacuum grippers become dirty or the vacuum gripper system can easily be maladjusted mechanically, reliability also leaves a lot to be desired.

In a method known from DE 36 03 627 C2, a holding device for the punching slug is used in connection with a plunge-through step which works with underpressure or comprises a separate gripper system. In this respect, the punching slug is raised from the workpiece together with the tool and is subsequently scraped off the tool. Problems can also still occur here in connection with the disposal of the punching slug.

It is the underlying object of the invention to provide an improved method and an improved apparatus of the initially named kind with which the previously mentioned problems have been eliminated. In this respect, in particular the reliability on the removal of the punch waste should be increased in as simple a manner as possible.

With respect to the method, this object is satisfied in accordance with the invention in that the movable base is retracted together with the punched out part into the cylindrical anvil up to and into the region of a lateral ejection opening provided in the cylindrical anvil and the punched out part supported on the retracted base is subsequently ejected through the ejection opening by loading with a corresponding force transversely to the axial direction. In this respect, the movable base is preferably arranged in a punching die.

An extremely reliable removal of the punch waste is ensured in a simple manner based on this aspect of the method.

In this respect, the force to be applied for the ejection of the punched out part is preferably applied onto the punched out part through an anvil opening disposed opposite the ejection opening.

The punched out part is advantageously ejected through the ejection opening by a brief force impulse.

In accordance with an expedient practical aspect of the method in accordance with the invention, the punched out part is ejected mechanically through the ejection opening. In this respect, the punched out part can in particular be ejected through the ejection opening via a slider or the like. Such a slider can in particular be guided from the outside through the anvil opening disposed opposite the ejection opening for the ejection of the punched out part.

In accordance with an advantageous alternative aspect of the method in accordance with the invention, the punched out part is ejected pneumatically through the ejection opening. In this respect, the punched out part can in particular be ejected through the ejection opening via a blast of compressed air.

It is in particular of advantage if the compressed air for the ejection of the punched out part is introduced into the anvil from the outside through the anvil opening disposed opposite the ejection opening.

The ejection opening can in particular be made in the form of a slot. In this respect, the height and width of the ejection slot is preferably selected to be only slightly larger than the width or height of the punched out part.

A preferred practical aspect of the method in accordance with the invention is characterized in that the anvil opening disposed opposite the ejection opening is made as a slot nozzle and the punched out part to be ejected is loaded via this slot nozzle.

If the ejection opening is also made in slot form, the slot nozzle advantageously extends at least substantially perpendicularly toward the ejection slot, whereby canting of the punched out part on passing through the ejection slot is avoided.

The passage comprising the ejection opening and the anvil opening disposed opposite it is preferably in particularly monitored by means of a light barrier and/or the like, whereby the process monitoring is simplified.

On the retraction of the movable base, the punched out part can be held at the base by vacuum.

The object set forth further above with respect to the apparatus is satisfied in accordance with the invention in that the movable base can be retracted together with the punched out part into the cylindrical anvil up to and into the region of a lateral ejection opening provided in the cylindrical anvil and means are provided to subsequently eject the punched out part supported on the retracted base through the ejection opening by loading with a corresponding force transversely to the axial direction.

Preferred embodiments of the apparatus in accordance with the invention are set forth in the dependent claims.

In particular with knife attachment cutting, the punching blade can therefore move toward an anvil with a spring base which can move away, with the spring base being able to be somewhat larger than the punched opening. The spring base which can move away is advantageous because after the punching frequently a coining procedure should take place with the shoulder of the punching stamp and sufficient free space must be available for this purpose beneath the punching stamp.

After the punching, the spring base is retracted downwardly together with the punched out part.

Now the stamped out part can be ejected during a next process step as long as the spring base remains in its lower position in which the punched out part is disposed opposite the ejection opening. A slot can therefore in particular be milled out of the fixed anvil and the punched out part is ejected through it. The diameter of the slot is expediently only slightly larger than the diameter of the waste piece or of the punched out part. It has been found that such an ejection slot does not impair the stability of the anvil provided that the usual punching forces and mechanical dimensions are observed.

The removal of the stamped out part advantageously takes place by a brief force impulse which can be generated either mechanically, for example using a universal stamp, or by a blast of compressed air. This universal removal can be included in the design and only requires slight adaptations to the part to be punched out or punched out on the putting into operation.

The respective nozzle can in particular be made as a slot nozzle. In this respect, it can in particular extend perpendicular to the ejection slot, whereby a canting of the punched out part on passing through the ejection slot is avoided.

Since the passage comprising the ejection opening as well as the anvil opening disposed opposite it is monitored by means of a light barrier, for example, the process monitoring can be simplified accordingly. The removal process can thus therefore in particular be monitored in a simple and reliable manner.

The slider can in particular be made in the form of a die or the like.

The invention will be explained in more detail in the following with reference to an embodiment and to the drawing; there are shown in this:

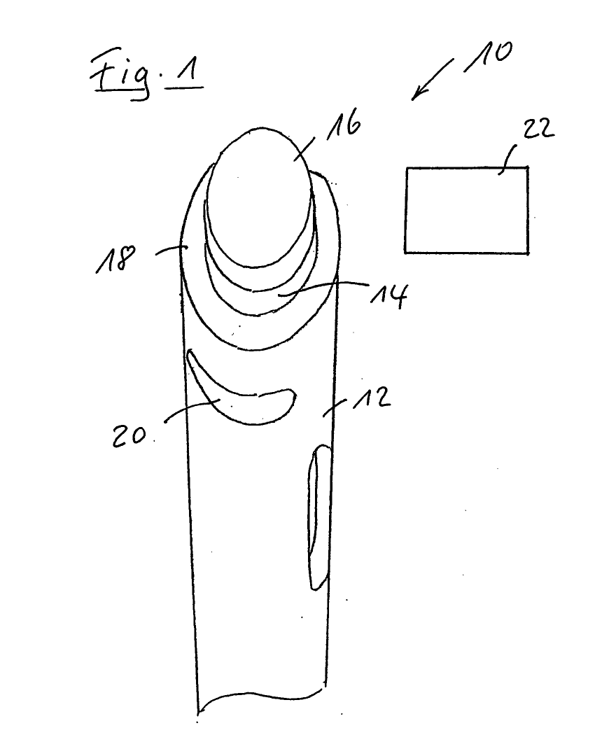

FIG. 1 a schematic perspective part representation of an exemplary embodiment of an apparatus for the removal of punch waste in a phase in which the movable base supporting the punched out part is still adopting its upper position;

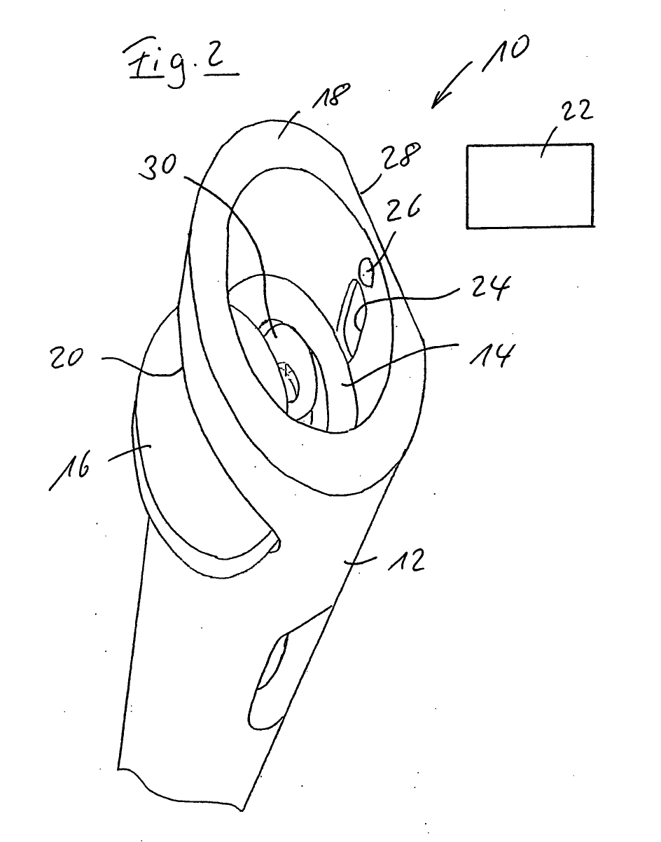

FIG. 2 a schematic perspective part representation of the apparatus in a phase in which the movable base has adopted its retracted position within the anvil and the punched out part is already partly ejected through the ejection opening; and

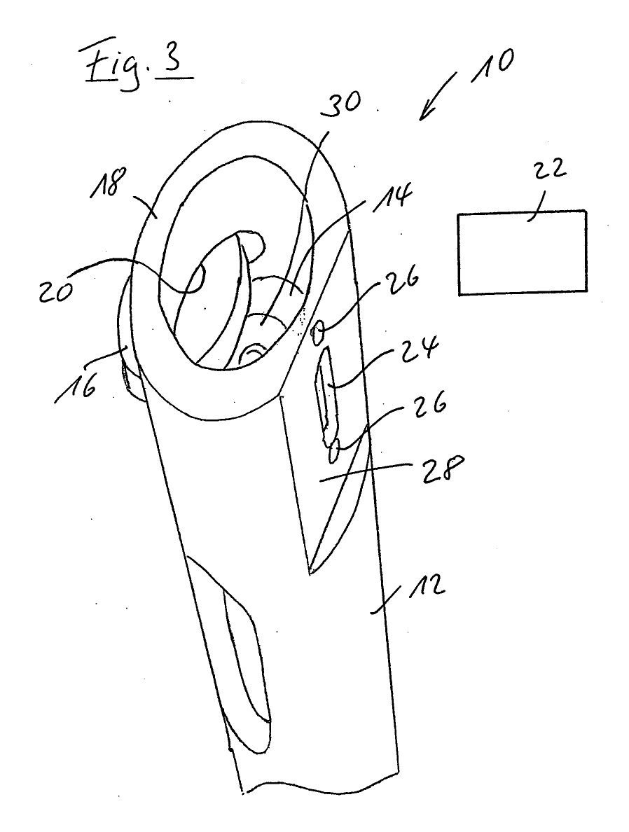

FIG. 3 a schematic perspective part representation of the apparatus of the same phase as FIG. 2, but with the side of the anvil disposed opposite the ejection opening also being able to be recognized.

FIGS. 1 to 3 show in a schematic perspective part representation an exemplary embodiment of an apparatus 10 for the removal of punch waste on punching, in particular punching using knife attachment cutting.

The apparatus 10 includes a cylindrical anvil 12 and a base 14, in particular a resilient base, axially movable therein. In this respect, this base 14 movable axially, i.e. in the longitudinal direction of the anvil 12, serves as a support for a part 16 which has been punched out of a workpiece, which is supported at an end face 18 of the anvil 12, by means of a punch blade.

The movable base 14 can be retracted together with the punched out part 16 into the cylindrical anvil 12 up to and into the region of a lateral ejection opening provided in the cylindrical anvil 12.

In addition, means 22 which are indicated only purely schematically are provided to subsequently eject the stamped out part 16 supported on the retracted base 14 through the lateral ejection opening 20 by loading with a corresponding force transversely to the axial or longitudinal direction of the anvil 12.

As can in particular be recognized with reference to FIGS. 2 and 3, the cylindrical anvil 12 is provided on the side disposed opposite the ejection opening 20 with an opening 24 through which the force to be applied for the ejection of the punched out part can be applied to the punched out part 16.

In this respect, this force is applied via the already mentioned force loading means 22 which can be attached to the anvil 12, for example screwed to it, adjacent to the anvil opening 24 on the side provided with this anvil opening 24.

As can in particular again be recognized with reference to FIGS. 2 and 3, the anvil can be provided for this purpose with fastening openings 26 which can each have an internal thread and into which the screws holding the force loading means 22 to the anvil 12 can be screwed. As can in particular be recognized with reference to FIG. 3, the anvil 12 can be flattened in the region 28 in which the force loading means 22 are fastened to the anvil 12.

The force loading means 22 can in particular be designed such that the punched out part 16 is ejected by a brief force impulse.

In this respect, mechanical and/or pneumatic force loading means 22 can be used.

If, for example, mechanical force action means 22 are provided, they can in particular include a slider via which the punched out part 16 can be ejected through the ejection opening 20. In this respect, such a slider for the ejection of the punched out part 16 can be led through the anvil opening 24 disposed opposite the ejection opening 20 from the outside.

Alternatively or additionally, in particular pneumatic force loading means 22 can, however, also be provided. In this respect, the pneumatic force loading means 22 can optionally in particular be designed such that the punched out part is ejected through the ejection opening 20 via a blast of compressed air.

The compressed air for the ejection of the punched out part 16 is introduced from the outside into the anvil 12 through the anvil opening 12 disposed opposite the ejection opening 20.

The ejection opening 20 can in particular be made in the form of a slot, with the height and width of the ejection slot expediently being selected to be only slightly larger than the maximum width or height of the punched out part 16.

If pneumatic force loading means 22 are provided, the anvil opening 24 disposed opposite the ejection opening 20 is expediently made as a slot nozzle, as can in particular be recognized with reference to FIGS. 2 and 3. The punched out part 16 to be ejected in this case is therefore accordingly loaded with compressed air via this slot nozzle. To avoid canting of the punched out part 16 on passing through the preferably slot-formed ejection opening 20, the slot nozzle 24 expediently extends perpendicular to the ejection slot 20.

In addition, means can be provided for the monitoring of the passage comprising the ejection opening 20 and the anvil opening 24 disposed opposite it, whereby the process control is accordingly facilitated. In this respect, these monitoring means can include a light barrier or the like, for example.

Expediently, means 30 are also provided in order, on the retraction of the movable base 14, to hold the punched out part 16 on it by vacuum. As can in particular be recognized with reference to FIGS. 2 and 3, the base 14, which can be resilient, for example, can be made in ring shape and the punched out part 16 can be loaded by vacuum through the ring-shaped base 14 via the means 30.

A correspondingly designed control and/or regulation device can be provided for the control and/or regulation of the movements of the base 14, which is in particular resilient, of the means 30 for the vacuum loading, of the force loading means 22 and/or of the monitoring means comprising a light barrier or the like, for example. This control and/or regulation device can in particular be integrated into a control and/or regulation device provided for the control and/or regulation of the remaining tool part in particular comprising the punching stamp and the punching blade.

Whereas in FIG. 1 the apparatus 10 is shown in a phase in which the movable base 14 supporting the stamped out part 16 is still adopting its upper position, the apparatus 10 is shown in FIGS. 2 and 3 respectively in a phase in which the movable base 14 has already adopted its retracted position, with the punched out part 16 already having been partly ejected through the ejection opening or through the ejection slot 20.

### REFERENCE NUMERAL LIST

10 apparatus
12 cylindrical anvil
14 base, in particular spring base
16 punched out part
18 end face
20 lateral ejection opening, ejection slot
22 force loading means
24 anvil opening, slot nozzle
26 fastening opening
28 fastening region
30 means for vacuum loading

1. A method for the removal of punch waste on punching, in particular punching using knife attachment cutting, in which, for the production by means of a punch blade of a punched opening in a workpiece supported at the end face (18) of a cylindrical anvil (12), a part (16) of the workpiece is punched out and the punched out part (16) lies before its removal on a base (14), in particular a resilient base, movable axially in the cylindrical anvil (12),
characterized in that
the movable base (14) is retracted together with the punched out part (16) into the cylindrical anvil (12) up to and into the region of a lateral ejection opening (20) provided in the cylindrical anvil (12) and the punched out part (16) supported on the retracted base (14) is subsequently ejected through the ejection opening (20) by loading with a corresponding force transversely to the axial direction.

2. A method in accordance with claim 1, characterized in that the force to be applied for the ejection of the punched out part (16) is applied to the punched out part (16) through an anvil opening (24) disposed opposite the ejection opening (20).

3. A method in accordance with claim 1, characterized in that the punched out part (16) is ejected through the ejection opening (20) by a short force impulse.

4. A method in accordance with claim 1, characterized in that the punched out part (16) is ejected through the ejection opening (20) mechanically.

5. A method in accordance with claim 4, characterized in that the punched out part (16) is ejected through the ejection opening (20) via a slider.

6. A method in accordance with claim 5, characterized in that the slider is guided from the outside through the anvil opening (24) disposed opposite the ejection opening (20) for the ejection of the punched out part (16).

7. A method in accordance with claim 1, characterized in that the punched out part (16) is ejected through the ejection opening (20) pneumatically.

8. A method in accordance with claim 7, characterized in that the punched out part (16) is ejected through the ejection opening (20) via a blast of compressed air.

9. A method in accordance with claim 7, characterized in that the compressed air for the ejection of the punched out part (16) is introduced from the outside into the anvil (12) through the anvil opening (24) disposed opposite the ejection opening (20).

10. A method in accordance with claim 1, characterized in that the ejection opening (20) is made in slot form.

11. A method in accordance with claim 10, characterized in that the height and width of the ejection slot (20) is selected to be only slightly larger than the width or height of the punched out part (16).

12. A method in accordance with claim 1, characterized in that the anvil opening (24) disposed opposite the ejection opening (20) is made as a slot nozzle and the punched out part (16) to be ejected is loaded via this slot nozzle.

13. A method in accordance with claim 12, characterized in that the ejection opening (20) is made in slot form and the slot nozzle (24) extends at least substantially perpendicularly to the ejection slot (20).

14. A method in accordance with claim 1, characterized in that the passage comprising the ejection opening (20) and the anvil opening (24) disposed opposite it is in particular monitored by means of a light barrier and/or the like.

15. A method in accordance with claim 1, characterized in that, on the retraction of the movable base (14), the punched out part (16) is held on it by vacuum.

16. An apparatus (10) for the removal of punch waste on punching, in particular stamping by knife attachment cutting, having a cylindrical anvil (12) and a base (14), in particular a spring base, which is axially movable in it and serves as a support for a part (16) which has been punched out by means of a punch blade from a workpiece supported at an end face (18) of the anvil (12), in particular for the carrying out of any one of the claim 1,
characterized in that
the movable base (14) can be retracted together with the punched out part (16) into the cylindrical anvil (12) up to and into the region of a lateral ejection opening (20) provided in the cylindrical anvil (12) and means (22) are provided to subsequently eject the punched out part (16) supported on the retracted base (14) through the ejection opening (20) by loading with a corresponding force transversely to the axial direction.

17. An apparatus in accordance with claim 16, characterized in that the cylindrical anvil (12) is provided on the side disposed opposite the ejection opening (20) with an opening (24) through which the force to be applied for the ejection of the punched out part (16) can be applied to the punched out part (16).

18. An apparatus in accordance with claim 16, characterized in that the force loading means (22) are designed such that the punched out part is ejected by a brief force impulse.

19. An apparatus in accordance with claim 16, characterized in that mechanical force loading means (22) are provided.

20. An apparatus in accordance with claim 19, characterized in that the mechanical force loading means (22) include a slider via which the punched out part (16) can be ejected through the ejection opening.

21. An apparatus in accordance with claim 20, characterized in that the slider for the ejection of the punched out part (16) is guided from the outside through the anvil opening (24) disposed opposite the ejection opening (20).

22. An apparatus in accordance with claim 16, characterized in that pneumatic force loading means (22) are provided.

23. An apparatus in accordance with claim 22, characterized in that the pneumatic force loading means (22) are designed such that the punched out part is ejected through the ejection opening (20) via a blast of compressed air.

24. An apparatus in accordance with claim 22, characterized in that the compressed air for the ejection of the punched out part (16) is introduced from the outside into the anvil (12) through the anvil opening (24) disposed opposite the ejection opening (20).

25. An apparatus in accordance with claim 16, characterized in that the ejection opening (20) is made in slot form.

26. An apparatus in accordance with claim 25, characterized in that the height and width of the ejection slot (20) are selected to be only slightly larger than the maximum width or height of the punched out part (16).

27. An apparatus in accordance with claim 16, characterized in that the anvil opening (24) disposed opposite the ejection opening (20) is made as a slot nozzle and the punched out part (16) to be ejected can be loaded via this slot nozzle.

28. An apparatus in accordance with claim 27, characterized in that the ejection opening is made in slot form and the slot nozzle (24) extends at least substantially perpendicularly to the ejection slot (20).

29. An apparatus in accordance with claim 16, characterized in that means are provided for the monitoring of the passage comprising the ejection opening (20) and the anvil opening (24) disposed opposite it.

30. An apparatus in accordance with claim 16, characterized in that the monitoring means comprise a light barrier.

31. An apparatus in accordance with claim 16, characterized in that means (30) are provided in order, on the retraction of the movable base (14), to hold the punched out part (16) on it by vacuum.
